(19) United States
(12) Patent Application Publication
(10) Pub. No.: US 2009/0041938 A1
(43) Pub. Date: Feb. 12, 2009

(54) MIXTURES OF FIBRE REACTIVE DYES PRODUCTION AND USE THEREOF

(75) Inventor: Andreas Giehl, Niedernhausen (DE)

Correspondence Address: CONNOLLY BOVE LODGE & HUTZ, LLP, P O BOX 2207, WILMINGTON, DE, 19899, US

(73) Assignee: DyStar Textilfarben GmbH & Co. Deutschland KG, Frankfurt am Main (DE)

(21) Appl. No.: 12/162,146

(22) PCT Filed: Jan. 19, 2007
(86) PCT No.: PCT/EP2007/050560

§ 371 Date: Aug. 12, 2008

(30) Foreign Application Priority Data
Jan. 26, 2006 (DE) 10 2006 003 621.2

(51) Int. Cl. B05D 5/00; C09B 62/008; C09B 62/35; C09D 11/02

(52) U.S. Cl. 427/256; 8/549; 106/31.51; 106/31.47

(57) ABSTRACT

The present invention concerns a dye mixture comprising at least one dye of the general formula (I)

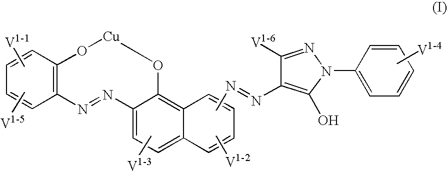

and at least one further dye either of the general formula (II)

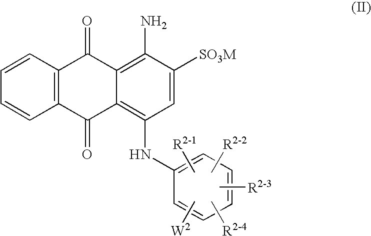

or of the general formula (III)

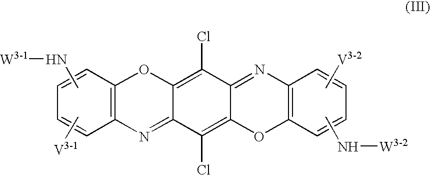

or of the general formula (IV)

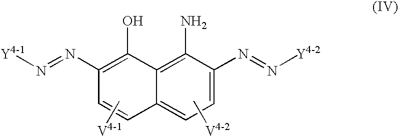

where the variables are each as defined in claim 1, processes for their preparation and their use.

The present invention relates to the field of reactive dyes and concerns dye mixtures useful for dyeing and printing fibrous materials containing hydroxyl or amide groups.

Numerous reactive dyes and reactive dye mixtures for dyeing and printing hydroxyl- or amide-containing fibrous materials are described in the literature, of which EP 1 275 700 A2 and DE 10 2004 028 919 A1 may be cited by way of example. However, these conventional dyes fall short, in particular in deep black and navy shades, of meeting the latest high expectations with regard to the fastness properties of dyed and printed products.

The present invention, then, provides dye mixtures whose dyeings surprisingly have distinctly superior fastness properties to the dye mixtures described in EP 1 275 700 A2 and DE 10 2004 028 919 A1, the chlorine fastness being particularly worthy of note. The mixtures of the present invention further give an improved build-up compared with the individual dyes in the mixture.

The dye mixtures of the present invention comprise at least one dye of the general formula (I)

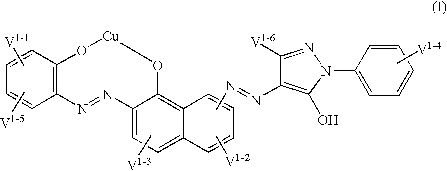

where
V¹⁻¹ represents vinyl sulfone or ethyl sulfone, substituted in the β-position by an alkali-eliminable substituent;
V¹⁻² and V¹⁻³ independently represent hydrogen or —SO₃M;
V¹⁻⁴ represents hydrogen, —SO₃M, vinyl sulfone or ethyl sulfone, substituted in the β-position by an alkali-eliminable substituent;
V¹⁻⁵ represents hydrogen, (C₁-C₄)-alkyl, (C₁-C₄)-alkoxy, —SO₃M, bromine or chlorine;
V¹⁻⁶ represents hydrogen, (C₁-C₆)-alkyl, —COOM, —COO—(C₁-C₄)-alkyl;
M represents hydrogen, an alkali metal, ammonium or the equivalent of an alkaline earth metal ion;
   and at least one further dye either of the general formula (II)

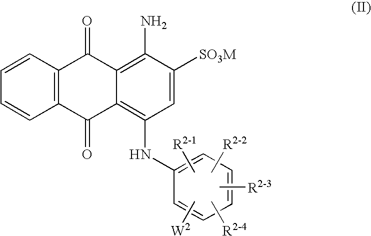

where
R²⁻¹ to R²⁻⁴ independently represent hydrogen, —SO₃M, (C₁-C₄)-alkyl or —COOR²⁻⁵;
W² represents —NR²⁻⁶D²;
R²⁻⁵ and R²⁻⁶ independently represent hydrogen or (C₁-C₄)-alkyl;
D² represents one of the following groups:

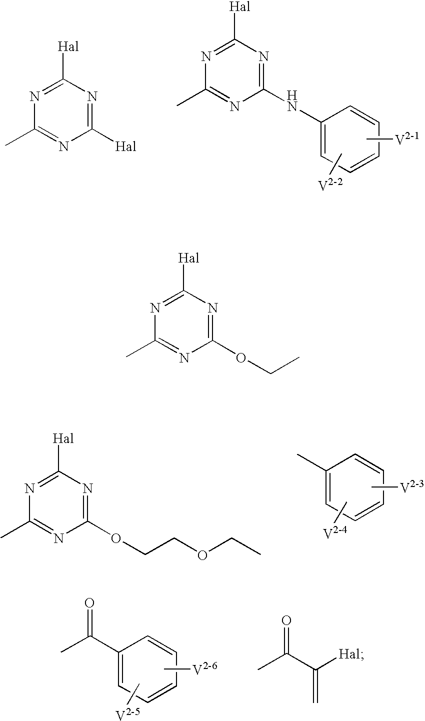

V²⁻¹ and V²⁻² independently represent hydrogen, —SO₃M, vinyl sulfone or ethyl sulfone, substituted in the β-position by an alkali-eliminable substituent;
V²⁻³ and V²⁻⁵ represent vinyl sulfone or ethyl sulfone, substituted in the β-position by an alkali-eliminable substituent;
V²⁻⁴ and V²⁻⁶ independently represent hydrogen or —SO₃M; and
Hal represents halogen;
and M is as defined above;
   or of the general formula (III)

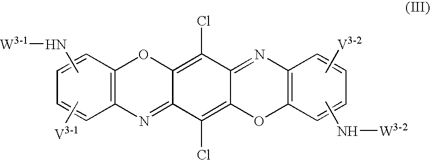

where
W³⁻¹ and W³⁻² independently represent hydrogen, (C₁-C₄)-alkyl, (C₁-C₄)-alkyl, substituted by —OSO₃M or represent one of the following groups:

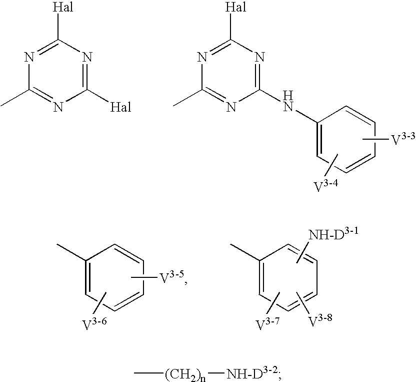

D³⁻¹ and D³⁻² independently represent one of the following groups:

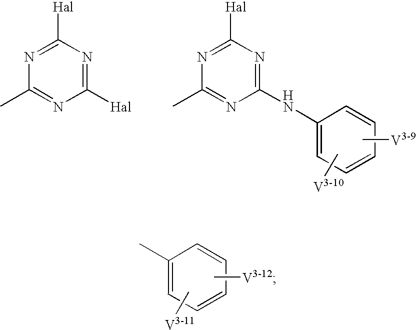

V³⁻¹ and V³⁻¹² independently represent hydrogen, —SO₃M, vinyl sulfone or ethyl sulfone, substituted in the β-position by an alkali-eliminable substituent; and
n represents 1, 2, 3 or 4;
and M and Hal are each as defined above;
   wherein the dye of the general formula (III) when V³⁻¹ to V³⁻¹² independently represent hydrogen or —SO₃M contains at least one structural element of the formula

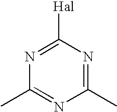

where Hal is as defined above;
or of the general formula (IV)

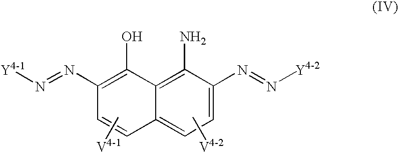

where
Y⁴⁻¹ represents the group of the formula

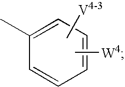

Y⁴⁻² has the same meanings as Y⁴⁻¹ or represents one of the following groups:

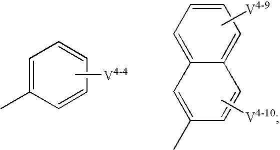

W⁴ represents vinyl sulfone or ethyl sulfone, substituted in the β-position by an alkali-eliminable substituent or —NR⁴⁻¹D⁴;
D⁴ represents one of the following groups:

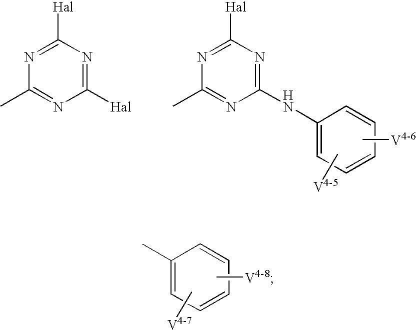

V⁴⁻¹ to V⁴⁻⁴ and V⁴⁻⁹ to V⁴⁻¹⁰ independently represent hydrogen or —SO₃M;
R⁴⁻¹ represents hydrogen, methyl or ethyl;
V⁴⁻⁵ to V⁴⁻⁷ independently represent hydrogen, —SO₃M, vinyl sulfone or ethyl sulfone, substituted in the β-position by an alkali-eliminable substituent; and
V⁴⁻⁸ represents vinyl sulfone or ethyl sulfone, substituted in the β-position by an alkali-eliminable substituent;
   and
and M is as defined above.

(C₁-C₄)-Alkyl and (C₁-C₆)-alkyl groups can be straight chain or branched and they represent for example methyl, ethyl, n-propyl, i-propyl, n-butyl, i-butyl or sec-butyl. (C₁-C₆)-Alkyl groups may also represent pentyl or hexyl for example. Preferred (C₁-C₄)-alkyl and (C₁-C₆)-alkyl groups are methyl and ethyl.

The same logic applies to (C₁-C₆)-alkoxy groups, which can accordingly represent for example methoxy, ethoxy, n-propoxy or i-propoxy, with methoxy being particularly preferred.

Examples of alkali-eliminable substituents in the β-position of ethyl sulfone are chlorine, —OSO₃M, —S—SO₃M, —OPO₃M₂, —SO₃M-substituted benzoyloxy and (C₂-C₅)-alkanoyloxy, for example acetyloxy, where M is as defined above. Preferred alkali-eliminable substituents in the β-position of ethyl sulfone are chlorine and —OSO₃M, in particular —OSO₃M.

M alkali metals are in particular sodium, potassium and lithium. Alkaline earth metals whose equivalent can represent M are in particular calcium and magnesium. M preferably represents hydrogen, sodium and potassium.

Halogen represents in particular fluorine, chlorine and bromine.

In the dyes of the general formula (I) to (IV), substituents representing vinyl sulfone or ethyl sulfone substituted in the β-position by an alkali-eliminable substituent, have both the meanings even though the particular dye is otherwise identical. More particularly these substituents can have the meanings of vinyl sulfone and β-sulfatoethyl sulfone. In this case, the fraction of the particular dye having the vinylsulfonyl group would be up to about 30 mol %, based on the particular overall dye quantity.

The dye mixtures of the present invention, as well as at least one dye of the general formula (I), may further comprise dyes of the general formulae (II) and (III) or (II) and (IV) or (III) and (IV). In addition, as well as at least one dye of the general formula (I), they may further comprise dyes of the general formulae (II), (III) and (IV).

Preferred dye mixtures in accordance with the present invention comprise a dye of the general formula (Ia)

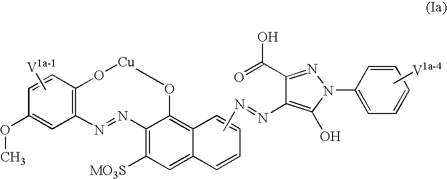

where
V^{1a-1} represents vinyl sulfone, sulfatoethyl sulfone or chloroethyl sulfone;
V^{1a-4} represents hydrogen, —SO₃M, vinyl sulfone, sulfatoethyl sulfone or chloroethyl sulfone; and
M represents hydrogen, sodium or potassium,
and at least one further dye of the general formulae (II), (III) or (IV).

Preferred dye mixtures in accordance with the present invention further include those comprising at least one dye of the general formula (I) and at least one further dye of the general formulae (IIb)

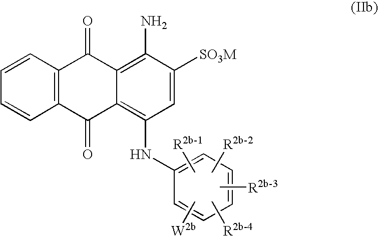

where
R^{2b-1} to R^{2b-4} independently represent hydrogen, —SO₃M, methyl or —COOR^{2b-5};
W^{2b} represents NR^{2b-6}D^{2b};
R^{2b-5} and R^{2b-6} independently represent hydrogen, methyl or ethyl;
D^{2b} represents one of the following groups:

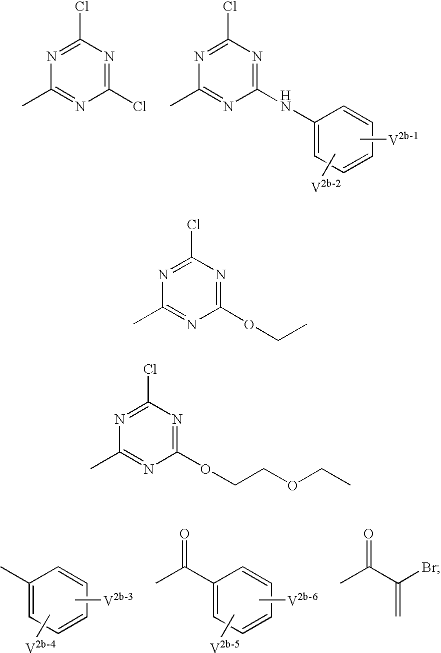

V^{2b-1} and V^{2b-2} independently represent hydrogen, —SO₃M, vinyl sulfone, sulfatoethyl sulfone or chloroethyl sulfone;
V^{2b-3} and V^{2b-5} independently represent vinyl sulfone, sulfatoethyl sulfone or chloroethyl sulfone;
V^{2b-4} and V^{2b-6} independently represent hydrogen or —SO₃M; and
M represents hydrogen, sodium or potassium.

Preferred dye mixtures in accordance with the present invention further include those comprising at least one dye of the general formula (I) and at least one further dye of the general formulae (IIIb)

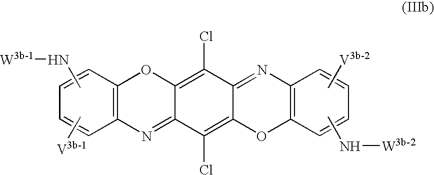

where
W^{3b-1} and W^{3b-2} independently represent hydrogen, (C₁-C₄)-alkyl, (C₁-C₄)-alkyl substituted by —OSO₃M or represent one of the following groups:

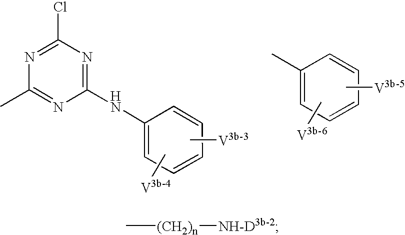

D^{3b-2} independently represents one group of the formulae

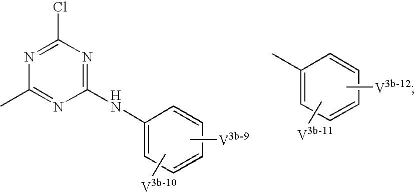

V^{3b-1} to V^{3b-5} and V^{3b-9} to V^{3b-11} independently represent hydrogen, SO₃M, vinyl sulfone, sulfatoethyl sulfone or chloroethyl sulfone;
V^{3b-6} and V^{3b-12} represent vinyl sulfone, sulfatoethyl sulfone or chloroethyl sulfone;
n represents the number 1, 2, 3 or 4; and
M represents hydrogen, sodium or potassium.

Finally, preferred dye mixtures in accordance with the present invention are those comprising at least one dye of the general formula (I) and at least one further dye of the general formulae (IVb)

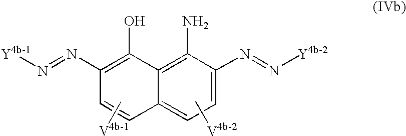

where
Y^{4b-1} represents the group of the formula

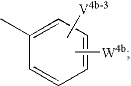

Y^{4b-2} has the same meanings as Y^{4b-1} or represents one of the following groups:

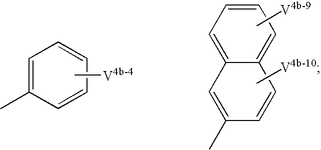

W^{4b} represents vinyl sulfone, sulfatoethyl sulfone, chlorosulfone or NR^{4b-4}D^{4b};
D^{4b} represents a group of the formulae

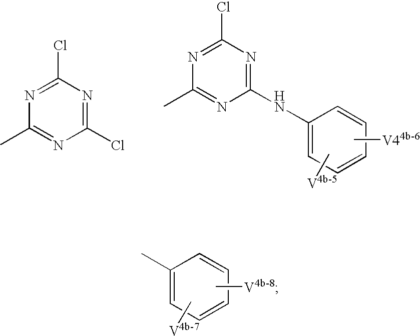

where
V^{4b-4} to V^{4b-3} and V^{4b-9} to V^{4b-10} independently represent hydrogen or SO₃M;
V^{4b-5} to V^{4b-7} independently represent hydrogen, SO₃M, vinyl sulfone, sulfatoethyl sulfone or chloroethyl sulfone;
V^{4b-8} represents vinyl sulfone, sulfatoethyl sulfone or chloroethyl sulfone;
R^{4b-4} represents hydrogen, methyl or ethyl; and
M represents hydrogen, sodium or potassium.

Particularly preferred dye mixtures in accordance with the present invention are those comprising at least one dye of the general formula (Ia) and at least one further dye either of the general formula (IIb) or of the general formula (IIIb) or of the general formula (IVb).

Particular preference is also given to dye mixtures in accordance with the present invention that comprise a dye of the general formulae (Ic)

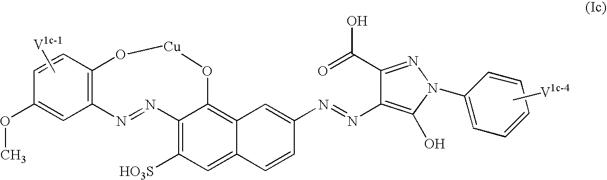

where
V^{1c-1} represents vinyl sulfone or sulfatoethyl sulfone;
V^{1c-4} represents —SO₃M and
M represents hydrogen or sodium,
and at least one further dye of the general formulae (II), (III) or (IV).

Particularly preferred dye mixtures in accordance with the present invention also include those comprising at least one dye of the general formula (I) and at least one further dye of the general formulae (IIc)

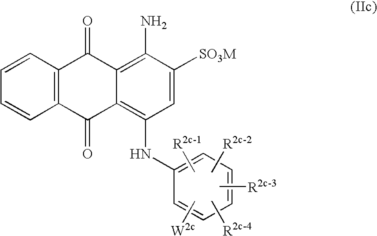

where
R^{2c-1} to R^{2c-3} independently represent hydrogen or methyl;
R^{2c-4} represents hydrogen or SO₃M;
W^{2c} represents —NHD^{2c}
D^{2c} represents one of the following groups:

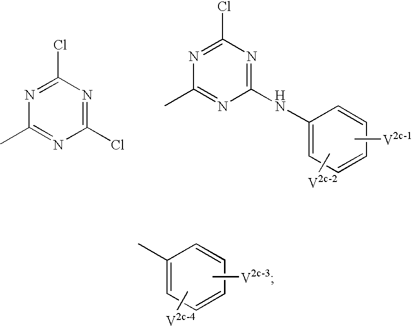

V^{2c-1} and V^{2c-3} independently represent hydrogen or SO₃M;
V^{2c-2} represents hydrogen, vinyl sulfone or sulfatoethyl sulfone;
V^{2c-4} represents vinyl sulfone or sulfatoethyl sulfone; and
M represents hydrogen or sodium.

Particularly preferred dye mixtures in accordance with the present invention further include those comprising at least one dye of the general formula (I) and at least one further dye of the general formulae (IIIc)

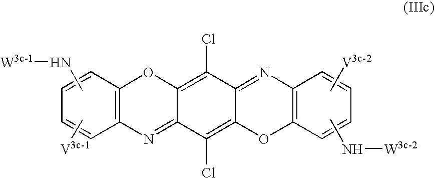

where
W^{3c-1} and W^{3c-2} independently represent (CH₂)₂—OSO₃M or one of the following groups:

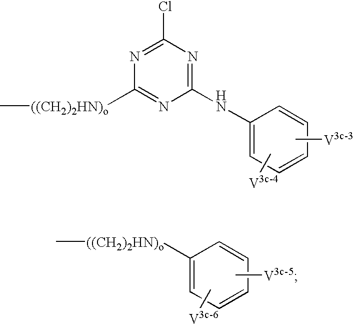

V^{3c-1} to V^{3c-4} independently represent hydrogen, SO₃M, vinyl sulfone or sulfatoethyl sulfone;
V^{3c-5} represent vinyl sulfone or sulfatoethyl sulfone;
V^{3c-6} represents hydrogen or SO₃M;
o represents 0 or 1; and
M represents hydrogen or sodium.

Finally, particularly preferred dye mixtures in accordance with the present invention are those comprising at least one dye of the general formula (I) and at least one further dye of the general formulae (IVc)

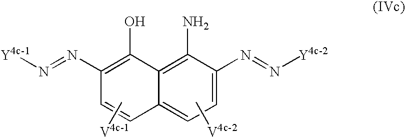

Y^{4c-1} represents the group of the formula

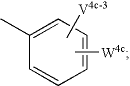

Y^{4c-2} has the same meanings as Y^{4c-1} or represents one of the following groups:

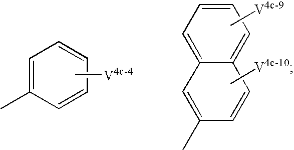

W^{4c} represents vinyl sulfone, sulfatoethyl sulfone or one of the following groups:

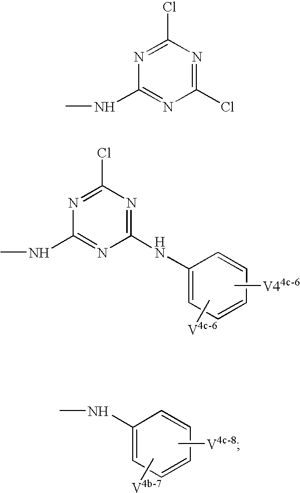

V^{4c-1} to V^{4c-3} represents —SO₃M;
V^{4c-5} to V^{4c-7} independently represent hydrogen, —SO₃M, vinyl sulfone or sulfatoethyl sulfone;
V^{4c-8} represents vinyl sulfone or sulfatoethyl sulfone;
V^{4c-4}, V^{4c-9} and V^{4c-10} independently represent hydrogen or —SO₃M; and
M represents hydrogen or sodium.

Very particularly preferred dye mixtures in accordance with the present invention are those comprising at least one dye of the general formula (Ic) and at least one further dye either of the general formula (IIc) or of the general formula (IIIc) or of the general formula (IVc).

The dye mixtures of the present invention comprise the dyes of the general formulae (I) and (II) and/or (III) and/or (IV) in weight ratios capable of varying within wide limits. Typically, dyes of the general formula (I) are present in amounts of 90% to 10% by weight and the dyes of the general formulae (II) and/or (III) and/or (IV) in amounts of 10% to 90% by weight. Preferably, dyes of the general formula (I) are present in amounts of 80% to 20% by weight and the dyes of the general formulae (II) and/or (III) and/or (IV) in amounts of 20% to 80% by weight. More preferably, dyes of the general formula (I) are present in amounts of 65% to 35% by weight and the dyes of the general formulae (II) and/or (III) and/or (IV) in amounts of 35% to 65% by weight. The same logic applies to dye mixtures in accordance with the present invention that comprise dyes of the general formulae (Ia), (IIb), (IIc), (IIIb), (IIIc), (IVb) or (IVc).

The dye mixtures of the present invention are obtainable in a conventional manner, for example by mechanically mixing the individual dyes of the general formulae (I) and (II), (III) or (IV) together, whether in the form of dye powders or granules or of as-synthesized solutions of the dyes of the general formulae (I) and (II), (III) or (IV), or of aqueous solutions of the dyes of the general formulae (I) and (II), (III) or (IV). The dye solutions mentioned may further comprise customary auxiliaries.

The dyes of the general formulae (I), (II), (III) and (IV) are known as individual substances and their preparation is described in the literature, and also known to one skilled in the art. They are commercially available as individual substances or preparable in a conventional manner.

The dye mixtures according to the invention can be present as a preparation in solid or liquid (dissolved) form.

In solid form, they contain, to the extent necessary, the electrolyte salts customary in the case of water-soluble and especially fiber-reactive dyes, such as sodium chloride, potassium chloride and sodium sulfate, and may further contain the auxiliaries customary in commercial dyes, such as buffer substances capable of setting a pH in aqueous solution between 3 and 7, for example sodium acetate, sodium citrate, sodium borate, sodium bicarbonate, sodium dihydrogenphosphate and disodium hydrogenphosphate, also dyeing auxiliaries, dustproofing agents and small amounts of siccatives; when they are present in a liquid, aqueous solution (including a content of thickeners of the type customary in print pastes), they may also contain substances which ensure a long life for these preparations, for example mold preventatives.

The dye mixtures of the present invention may contain further fiber-reactive dyes in any desired amounts. For example, they may contain dyes used for shading the dye mixture in an amount of up to 5% by weight. These further dyes can be added by customary mixing or else be chemically synthesized in the same reaction batch together with the synthesis of dye mixture in accordance with the present invention and introduced into the dye mixture when one or more precursors of the further dye are identical with one or more precursors of the dyes of the general formulae (I) and/or (II) and/or (III) and/or (IV).

The present invention also provides for the use of the present invention's dye mixtures for dyeing or printing hydroxyl- and/or carboxamido-containing materials, or a process for dyeing or printing a hydroxyl- and/or carboxamido-containing material whereby a dye mixture is applied to the material and fixed on the material by means of heat and/or by means of an alkaline agent, the process utilizing a dye mixture in accordance with the present invention. The dyeings and prints obtained are navy to black.

Hydroxyl-containing materials can be of natural or synthetic origin. Examples are cellulose fiber materials, preferably cotton, linen, hemp, jute and ramie fibers, regenerated cellulose fibers such as preferably staple viscose and filament viscose, chemically modified cellulose fibers, such as for example aminated cellulose fibers, and also polyvinyl alcohols.

Carboxamido-containing materials are for example synthetic and natural polyamides and polyurethanes, for example wool and other animal hairs, silk, leather, nylon-6,6, nylon-6, nylon-11 and nylon-4.

The hydroxyl- and/or carboxamido-containing materials mentioned can be present in various forms. For instance in the form of sheetlike structures, such as paper and leather, in the form of films, such as nylon films, or in the form of a bulk mass, for example composed of polyamide and polyurethane, in particular in the form of fibers, for example cellulose fibers. The fibers are preferably textile fibers, for example in the form of woven fabrics or yarns or in the form of hanks or wound packages.

The dye mixtures according to the invention can be applied to and fixed on the materials mentioned, especially the fiber materials mentioned, by the application techniques known for water-soluble dyes and especially for fiber-reactive dyes. For instance, on cellulose fibers they produce by the exhaust method from a long liquor and also from a short liquor, for example in a liquor to goods ratio of 5:1 to 100:1, preferably 6:1 to 30:1, using various acid-binding agents and optionally neutral salts as far as necessary, such as sodium chloride or sodium sulfate, dyeings having very good color yields. Application is preferably from an aqueous bath at temperatures between 40 and 105° C., optionally at a temperature of up to 130° C. under superatmospheric pressure, but preferably at 30 to 95° C., especially 45 to 65° C., in the presence or absence of customary dyeing auxiliaries.

One possible procedure here is to introduce the material into the warm bath and to gradually heat the bath to the desired dyeing temperature and complete the dyeing process at that temperature. The neutral salts which accelerate the exhaustion of the dyes may also if desired only be added to the bath after the actual dyeing temperature has been reached.

Padding processes likewise provide excellent color yields and a very good color buildup on cellulose fibers, the dyes being fixable in a conventional manner by batching at room temperature or elevated temperature, for example at up to about 60° C., or in a continuous manner, for example by means of a pad-dry-pad steam process, by steaming or using dry heat.

Similarly, the customary printing processes for cellulose fibers, which can be carried out in one step, for example by printing with a print paste containing sodium bicarbonate or some other acid-binding agent and by subsequent steaming at 100 to 103° C., or in two steps, for example by printing with a neutral or weakly acidic print color and then fixing either by passing the printed material through a hot electrolyte-containing alkaline bath or by overpadding with an alkaline electrolyte-containing padding liquor and subsequent batching or steaming or dry heat treatment of the alkali-overpadded material, produce strong color prints with well-defined contours and a clear white ground. The outcome of the prints is affected little, if at all, by variations in the fixing conditions.

When fixing by means of dry heat in accordance with the customary thermofix processes, hot air at 120 to 200° C. is used. In addition to the customary steam at 101 to 103° C., it is also possible to use superheated steam and high-pressure steam at temperatures of up to 160° C.

The acid-binding agents which effect the fixation of the dyes of the dye mixtures according to the invention on the cellulose fibers are for example water-soluble basic salts of alkali metals and likewise alkaline earth metals of inorganic or organic acids or compounds which liberate alkali in the heat, and also alkali metal silicates. Especially suitable are the alkali metal hydroxides and alkali metal salts of weak to medium inorganic or organic acids, the preferred alkali metal compounds being the sodium and potassium compounds. Such acid-binding agents are for example sodium hydroxide, potassium hydroxide, sodium carbonate, sodium bicarbonate, potassium carbonate, sodium formate, sodium dihydrogenphosphate, disodium hydrogenphosphate, sodium trichloroacetate, trisodium phosphate or waterglass or mixtures thereof, for example mixtures of aqueous sodium hydroxide solution and waterglass.

The dye mixtures according to the invention when applied to the cellulose fiber materials by dyeing or printing are notable for outstanding color strength, at times achievable in the presence of no or very small amounts of alkali or alkaline earth metal compounds. In these special cases, for instance, no electrolyte salt is required for a shallow depth of shade, not more than 5 g/l of electrolyte salt is required for a medium depth of shade and not more than 10 g/l of electrolyte salt is required for deep shades.

According to the invention, a shallow depth of shade refers to the use of 2% by weight of dye based on the substrate to be dyed, a medium depth of shade refers to the use of 2 to 4% by weight of dye based on the substrate to be dyed and a deep shade refers to the use of 4 to 10% by weight of dye based on the substrate to be dyed.

The dyeings and prints obtainable with the dye mixtures according to the invention possess bright shades; more particularly, the dyeings and prints on cellulose fiber materials possess good lightfastness and especially good wetfastnesses, such as fastness to washing, milling, water, seawater, crossdyeing and acidic and alkaline perspiration, also good fastness to pleating, hotpressing and rubbing. The chlorine fastness in particular is very good.

Furthermore, the dye mixtures according to the invention can also be used for the fiber-reactive dyeing of wool. This also includes wool which has been given a nonfelting or low-felting finish (cf. for example H. Rath, Lehrbuch der Textilchemie, Springer-Verlag, 3rd edition (1972), pages 295-299, especially finished by the Hercosett process (page 298); J. Soc. Dyers and Colourists 1972, 93-99, and 1975, 33-44). The process of dyeing on wool is here carried out in a conventional manner from an acidic medium. For instance, acetic acid and/or ammonium sulfate or acetic acid and ammonium acetate or sodium acetate can be added to the dyebath to obtain the desired pH. To obtain a dyeing of acceptable levelness, it is advisable to add a customary leveling agent, for example a leveling agent based on a reaction product of cyanuric chloride with three times the molar amount of an aminobenzenesulfonic acid and/or of an aminonaphthalenesulfonic acid or on the basis of a reaction product of for example stearylamine with ethylene oxide. For instance, the dye mixture according to the invention is preferably subjected to the exhaust process initially from an acidic dyebath having a pH of about 3.5 to 5.5 under pH control and the pH is then, toward the end of the dyeing time, shifted into the neutral and optionally weakly alkaline range up to a pH of 8.5 to bring about, especially for very deep dyeings, the full reactive bond between the dyes of the dye mixtures according to the invention and the fiber. At the same time, the dye portion not reactively bound is removed.

The procedure described herein also applies to the production of dyeings on fiber materials composed of other natural polyamides or of synthetic polyamides and their mixture with polyurethanes. In general, the material to be dyed is introduced into the bath at a temperature of about 40° C., agitated therein for some time, the dyebath is then adjusted to the desired weakly acidic, preferably weakly acetic acid, pH and the actual dyeing is carried out at a temperature between 60 and 98° C. However, the dyeings can also be carried out at the boil or in sealed dyeing apparatus at temperatures of up to 106° C.

Since the water solubility of the dye mixtures according to the invention is very good, they can also be used with advantage in customary continuous dyeing processes.

The dye mixtures of the present invention can also be used in digital printing processes, in particular in digital textile printing. For this the dye mixtures of the present invention need to be formulated in inks. Aqueous inks for digital printing which comprise a dye mixture in accordance with the present invention likewise form part of the subject matter of the present invention.

The inks of the present invention comprise the dye mixture of the present invention in amounts which preferably range from 0.1% by weight to 50% by weight, more preferably from 1% by weight to 30% by weight and most preferably from 1% by weight to 15% by weight, based on the total weight of the ink. The inks, as well as the dye mixture of the present invention, may if desired contain further reactive dyes used in digital printing.

For the inks of the present invention to be used in the continuous flow process, a conductivity of 0.5 to 25 mS/m can be set by adding an electrolyte. Useful electrolytes include for example lithium nitrate and potassium nitrate. The inks of the present invention may include organic solvents at a total level of 1-50% and preferably 5-30% by weight. Suitable organic solvents are for example alcohols, for example methanol, ethanol, 1-propanol, isopropanol, 1-butanol, tert-butanol, pentyl alcohol, polyhydric alcohols for example: 1,2-ethanediol, 1,2,3-propanetriol, butanediol, 1,3-butanediol, 1,4-butanediol, 1,2-propanediol, 2,3-propanediol, pentanediol, 1,4-pentanediol, 1,5-pentanediol, hexanediol, D,L-1,2-hexanediol, 1,6-hexanediol, 1,2,6-hexanetriol, 1,2-octanediol, polyalkylene glycols, for example: polyethylene glycol, polypropylene glycol, alkylene glycols having 1 to 8 alkylene groups, for example: monoethylene glycol, diethylene glycol, triethylene glycol, tetraethylene glycol, thioglycol, thiodiglycol, butyltriglycol, hexylene glycol, propylene glycol, dipropylene glycol, tripropylene glycol, low alkyl ethers of polyhydric alcohols, for example: ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, diethylene glycol monohexyl ether, triethylene glycol monomethyl ether, triethylene glycol monobutyl ether, tripropylene glycol monomethyl ether, tetraethylene glycol monomethyl ether, tetraethylene glycol monobutyl ether, tetraethylene glycol dimethyl ether, propylene glycol monomethyl ether, propylene glycol monoethyl ether, propylene glycol monobutyl ether, tripropylene glycol isopropyl ether, polyalkylene glycol ethers, such as for example: polyethylene glycol monomethyl ether, polypropylene glycol glycerol ether, polyethylene glycol tridecyl ether, polyethylene glycol nonylphenyl ether, amines, such as for example: methylamine, ethylamine, triethylamine, diethylamine, dimethylamine, trimethylamine, dibutylamine, diethanolamine, triethanolamine, N-acetylethanolamine, N-formylethanolamine, ethylenediamine, urea derivatives, such as for example: urea, thiourea, N-methylurea, N,N′-epsilon dimethylurea, ethyleneurea, 1,1,3,3-tetramethylurea, amides, such as for example: dimethylformamide, dimethylacetamide, acetamide, ketones or keto alcohols, such as for example: acetone, diacetone alcohol, cyclic ethers, such as for example: tetrahydrofuran, trimethylolethane, trimethylolpropane, 2-butoxyethanol, benzyl alcohol, 2-butoxyethanol, gamma butyrolactone, epsilon-caprolactam, further sulfolane, dimethylsulfolane, methylsulfolane, 2,4-dimethylsulfolane, dimethyl sulfone, butadiene sulfone, dimethyl sulfoxide, dibutyl sulfoxide, N-cyclohexylpyrrolidone, N-methyl-2-pyrrolidone, N-ethylpyrrolidone, 2-pyrrolidone, 1-(2-hydroxyethyl)-2-pyrrolidone, 1-(3-hydroxypropyl)-2-pyrrolidone, 1,3-dimethyl-2-imidazolidinone, 1,3-dimethyl-2-imidazolinone, 1,3-bismethoxymethylimidazolidine, 2-(2-methoxyethoxy)ethanol, 2-(2-ethoxyethoxy)ethanol, 2-(2-butoxyethoxy)ethanol, 2-(2-propoxyethoxy)ethanol, pyridine, piperidine, butyrolactone, trimethylpropane, 1,2-dimethoxypropane, dioxane ethyl acetate, ethylenediaminetetraacetate ethyl pentyl ether, 1,2-dimethoxypropane and trimethylpropane.

The inks of the invention may further include customary additives, for example viscosity moderators to set viscosities in the range from 1.5 to 40.0 mPas in a temperature range from 20 to 50° C. Preferred inks have a viscosity of 1.5 to 20 mPas and particularly preferred inks have a viscosity of 1.5 to 15 mPas.

Useful viscosity moderators include rheological additives, for example: polyvinylcaprolactam, polyvinylpyrrolidone and their copolymers polyetherpolyol, associative thickeners, polyurea, polyurethane, sodium alginates, modified galactomannans, polyetherurea, polyurethane, nonionic cellulose ethers.

As further additives the inks of the invention may include surface-active substances to set surface tensions of 20 to 65 mN/m, which are adapted if necessary as a function of the process used (thermal or piezo technology). Useful surface-active substances include for example: all surfactants, preferably nonionic surfactants, butyldiglycol, 1,2-hexanediol.

The inks of the present invention may further include customary additives, for example substances to inhibit fungal and bacterial growth in amounts from 0.01 to 1% by weight based on the total weight of the ink.

The inks may be prepared in a conventional manner by mixing the components in 20 water.

The inks of the invention are particularly useful in inkjet printing processes for printing a wide variety of pretreated materials, such as silk, leather, wool, polyamide fibers and polyurethanes, and especially cellulosic fiber materials of any kind. Blend fabrics, for example blends of cotton, silk, wool with polyester fibers or polyamide fibers can similarly be printed.

In contrast to conventional textile printing, where the printing ink already contains all the fixing chemicals and thickeners for a reactive dye, in digital or inkjet printing the auxiliaries have to be applied to the textile substrate in a separate pretreatment step.

The pretreatment of the textile substrate, for example cellulose and regenerated cellulose fibers and also silk and wool, is effected with an aqueous alkaline liquor prior to printing. To fix reactive dyes there is a need for alkali, for example sodium carbonate, sodium bicarbonate, sodium acetate, trisodium phosphate, sodium silicate, sodium hydroxide, alkali donors such as, for example, sodium chloroacetate, sodium formate, hydrotropic substances such as, for example, urea, reduction inhibitors, for example sodium nitrobenzenesulfonates, and also thickeners to prevent flowing of the motives when the printing ink is applied, for example sodium alginates, modified polyacrylates or highly etherified galactomannans.

These pretreatment reagents are uniformly applied to the textile substrate in a defined amount using suitable applicators, for example using a 2- or 3-roll pad, contactless spraying technologies, by means of foam application or using appropriately adapted inkjet technologies, and subsequently dried.

After printing, the textile fiber material is dried at 120 to 150° C. and subsequently fixed.

The fixing of the inkjet prints prepared with reactive dyes may be effected at room temperature or with saturated steam, with superheated steam, with hot air, with microwaves, with infrared radiation, with laser or electron beams or with other suitable energy transfer techniques.

A distinction is made between one- and two-phase fixing processes. In one-phase fixing, the necessary fixing chemicals are already on the textile substrate. In two-phase fixing, this pretreatment is unnecessary. Fixing only requires alkali, which, following inkjet printing, is applied prior to the fixing process, without intermediate drying. There is no need for further additives such as urea or thickener.

Fixing is followed by the print aftertreatment, which is the prerequisite for good fastnesses, high brilliance and an impeccable white ground.

The prints produced with the inks of the present invention, in particular on cellulosic fiber materials, possess high color strength and a high fiber-dye bond stability not only in the acidic but also in the alkaline region, also good lightfastness and very good wet fastness properties such as fastness to washing, water, seawater, crossdyeing and perspiration, and also good fastness to pleating, hotpressing and rubbing.

The examples hereinbelow serve to illustrate the invention. Parts and percentages are by weight, unless otherwise stated. Parts by weight relate to parts by volume as the kilogram relative to the liter. The compounds described in the examples in terms of a formula are indicated in the form of the sodium salts, since they are generally prepared and isolated in the form of their salts, preferably sodium or potassium salts, and used for dyeing in the form of their salts. The starting compounds described in the examples hereinbelow can be used in the synthesis in the form of the free acid or likewise in the form of their salts, preferably alkali metal salts, such as sodium or potassium salts, i.e., M is as defined above.

### EXAMPLE 1

800 parts of an as-synthesized aqueous solution containing 100 parts of the dye of the formula (I-2)

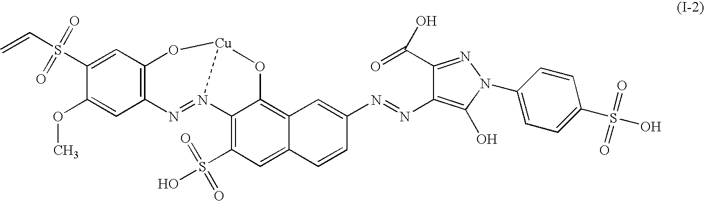

and 1000 parts of an as-synthesized aqueous solution containing 98.4 parts of the dyes of the formula (III-1)

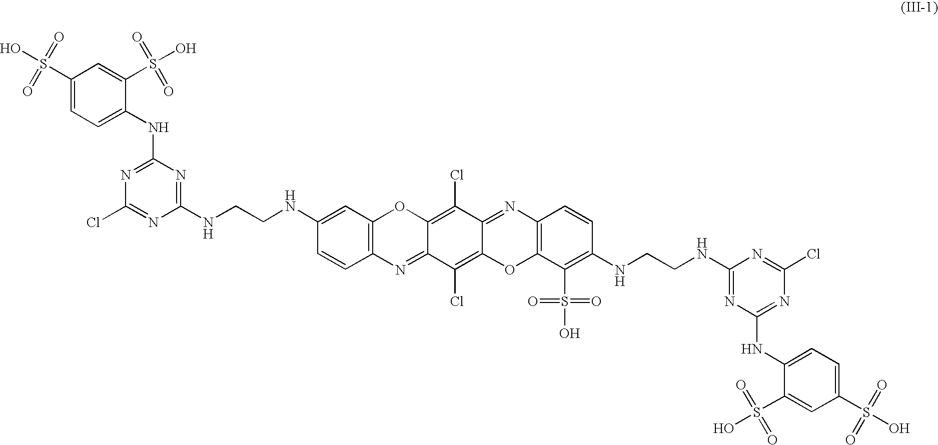

are mixed together. The combined solution is treated in a conventional manner, for example by spray drying, to isolate a dye mixture having a molar mixing ratio of dye (I-2) to dye (III-1) of 60:40. The mixture contains electrolyte salts, such as sodium chloride and sodium sulfate, from the respective dye synthesis, and demonstrates very good dyeing properties. 95 parts of this mixture and 5 parts of a red-dyeing fiber-reactive shading component provide, for example on natural and synthetic fiber materials, such as wool or nylon-6,6, in a dyeing process customary for fiber-reactive dyes, strong and level navy dyeings possessing good fastness to light.

### EXAMPLE 2

500 parts of an aqueous solution containing 70 parts of the dye of the formula (I-3)

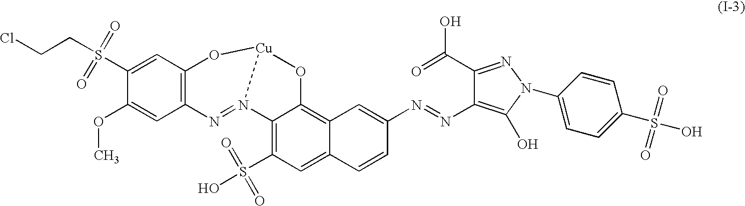

and 500 parts of an aqueous solution containing 70 parts of the dyes of the formula (II-3)

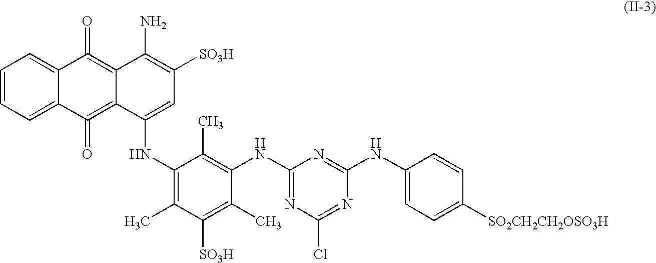

are mixed together. The combined solution is treated in a conventional manner, for example by spray drying, to isolate a dye mixture having a molar mixing ratio of dye (I-3) to dye (II-3) of 52:48. The mixture contains electrolyte salts, such as sodium chloride and sodium sulfate, from the respective dye synthesis, and demonstrates very good dyeing properties. It provides for example on cellulosic fiber materials, such as cotton, or regenerated cellulose fibers in an exhaust dyeing process customary for fiber reactive dyes, strong and level grayish blue dyeings.

### EXAMPLES 3 to 17

The examples which follow describe further dye mixtures in accordance with the present invention which have very good application properties and provide on the materials mentioned in the description, in particular cellulose fiber materials, by the dyeing and printing methods customary in the art, preferably by the application and fixing methods customary in the art for fiber-reactive dyes, strong bluish gray dyeings and prints having good fastness properties and a good color build-up.

These mixtures in combination with a red-dyeing fiber-reactive component further provide on natural and synthetic polyamide materials, for example wool or nylon-6,6, in a dyeing method customary for fiber-reactive dyes, strong and level navy dyeings having good fastness to light.

| | | | Molar ratio of |
|---|---|---|---|
| | Dye of | Dye of formula | dye (I): |
| Example | formula (I) | (II), (III) or (IV) | dye (II), (III) or (IV) |
| 3 | formula (I-1) | formula (II-4) | 52:48 |
| 4 | formula (I-2) | formula (II-5) | 50:50 |
| 5 | formula (I-3) | formula (II-6) | 49:51 |
| 6 | formula (I-1) | formula (II-7) | 50:50 |
| 7 | formula (I-1) | formula (II-8) | 47:53 |
| 8 | formula (I-2) | formula (II-9) | 52:48 |
| 9 | formula (I-3) | formula (III-2) | 50:50 |
| 10 | formula (I-1) | formula (III-2) | 62:38 |
| 11 | formula (I-2) | formula (III-2) | 70:30 |
| 12 | formula (I-3) | formula (VI-1) | 40:60 |
| 13 | formula (I-1) | formula (VI-1) | 52:48 |
| 14 | formula (I-2) | formula (VI-1) | 65:35 |
| 15 | formula (I-3) | formula (VI-2) | 47:53 |
| 16 | formula (I-1) | formula (VI-2) | 36:64 |
| 17 | formula (I-2) | formula (VI-2) | 54:46 |

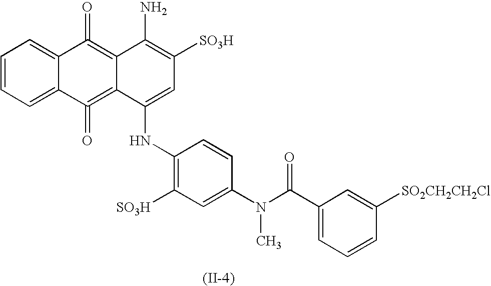

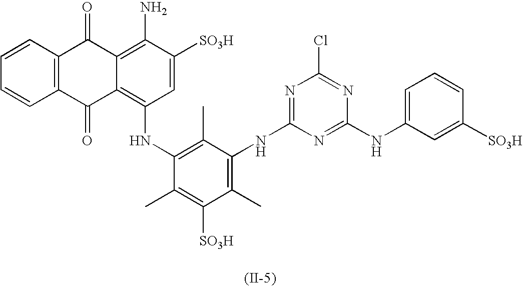

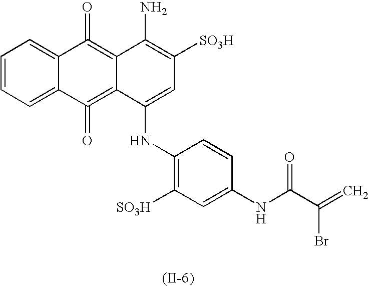

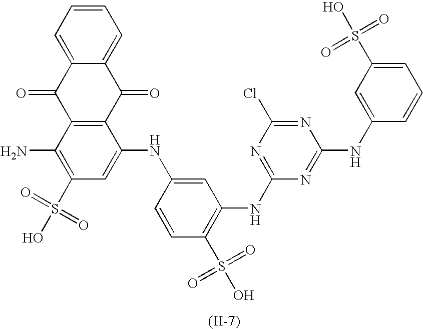

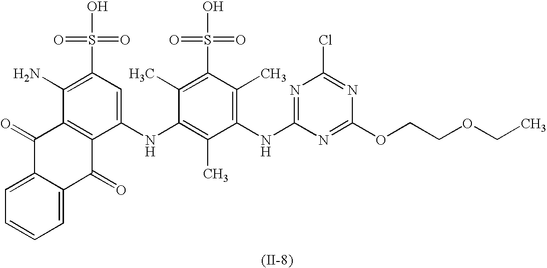

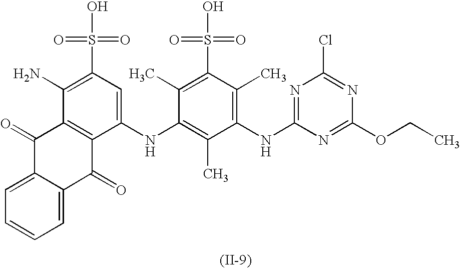

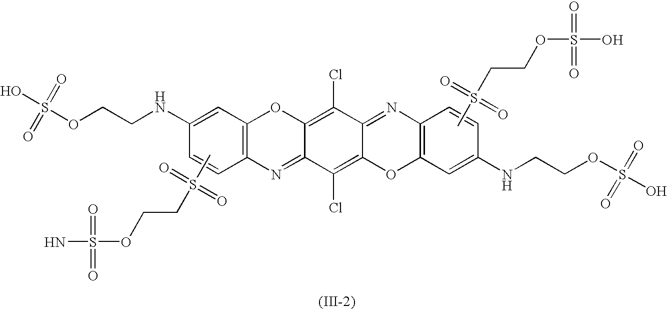

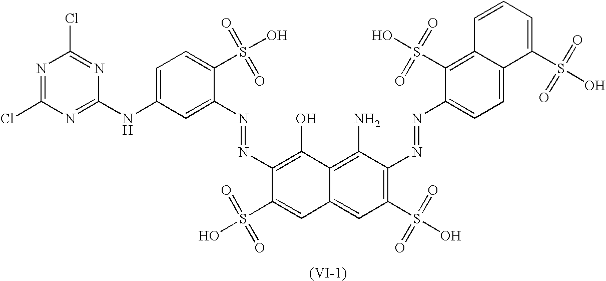

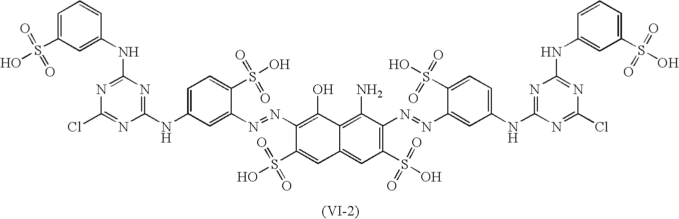

### EXAMPLE 18

A textile fabric consisting of mercerized cotton is padded with liquor containing 35 g/l of anhydrous sodium carbonate, 50 g/l of urea and 150 g/l of a low viscosity sodium alginate solution (6%) and then dried. The wet pick-up is 70%. The textile thus pretreated is printed with an aqueous ink containing 8% of a dye mixture according to Example 1, 20% of 1,2-propanediol, 0.01% of Mergal K9N and 71.99% of water using a drop-on-demand (bubble jet) ink jet print head The print is fully dried. Fixation is effected by means of saturated steam at 102° C. for 8 minutes. The print is subsequently rinsed warm, subjected to a fastness wash with hot water at 95° C., rinsed warm and then dried to obtain a grayish blue print having excellent service fastnesses.

### EXAMPLE 19

A textile fabric consisting of mercerized cotton is padded with liquor containing 35 g/l of anhydrous sodium carbonate, 100 g/l of urea and 150 g/l of a low viscosity sodium alginate solution (6%) and then dried. The wet pick-up is 70%. The textile thus pretreated is printed with an aqueous ink containing 8% of a dye mixture according to Example 2, 15% of N-methylpyrrolidone, 0.01% of Mergal K9N and 76.99% of water using a drop-on-demand (bubble jet) ink jet print head. The print is fully dried. Fixation is effected by means of saturated steam at 102° C. for 8 minutes. The print is subsequently rinsed warm, subjected to a fastness wash with hot water at 95° C., rinsed warm and then dried to obtain a grayish blue print having excellent service fastnesses.

1-10. (canceled)

11. A dye mixture comprising at least one dye of the formula (I), 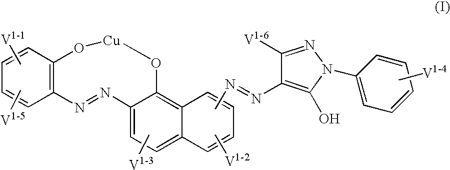
wherein
V¹⁻¹ represents vinyl sulfone or ethyl sulfone, substituted in the β-position by an alkali-eliminable substituent;
V¹⁻² and V¹⁻³ independently represent hydrogen or —SO₃M;
V¹⁻⁴ represents hydrogen, —SO₃M, vinyl sulfone or ethyl sulfone, substituted in the β-position by an alkali-eliminable substituent;
V¹⁻⁵ represents hydrogen, (C₁-C₄)-alkyl, (C₁-C₄)-alkoxy, —SO₃M, bromine or chlorine;
V¹⁻⁶ represents hydrogen, (C₁-C₆)-alkyl, —COOM, —COO—(C₁-C₄)-alkyl;
M represents hydrogen, an alkali metal, ammonium or the equivalent of an alkaline earth metal ion;
and at least one further dye either of the formula (II) 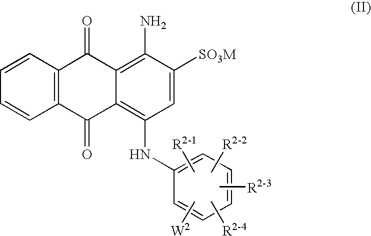
where
R²⁻¹ to R²⁻⁴ independently represent hydrogen, —SO₃M, (C₁-C₄)-alkyl or —COOR²⁻⁵;
W² represents —NR²⁻⁶D²;
R²⁻⁵ and R²⁻⁶ independently represent hydrogen or (C₁-C₄)-alkyl;
D² represents one of the following groups: 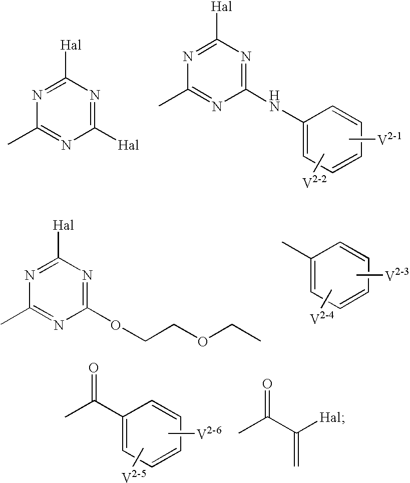
V²⁻¹ and V²⁻² independently represent hydrogen, —SO₃M, vinyl sulfone or ethyl sulfone, substituted in the β-position by an alkali-eliminable substituent;
V²⁻³ and V²⁻⁵ represent vinyl sulfone or ethyl sulfone, substituted in the β-position by an alkali-eliminable substituent;
V²⁻⁴ and V²⁻⁶ independently represent hydrogen or —SO₃M; and
Hal represents halogen;
and M is as defined above;
or of the formula (III) 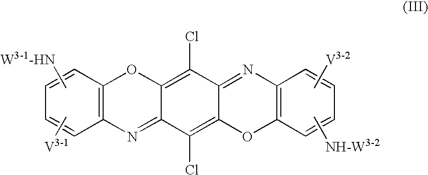
where
W³⁻¹ and W³⁻² independently represent hydrogen, (C₁-C₄)-alkyl, (C₁-C₄)-alkyl, substituted by —OSO₃M or represent one of the following groups: 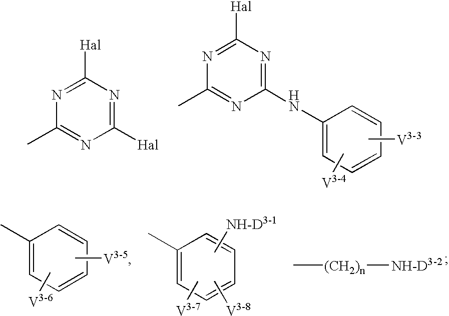
D³⁻¹ and D³⁻² independently represent one of the following groups: 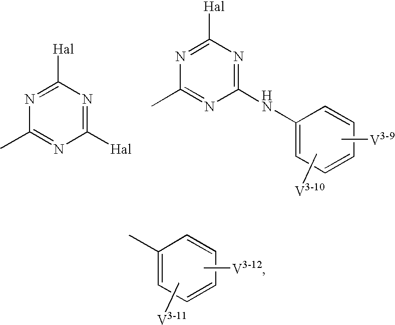
V³⁻¹ and V³⁻¹² independently represent hydrogen, —SO₃M, vinyl sulfone or ethyl sulfone, substituted in the β-position by an alkali-eliminable substituent; and
n represents 1, 2, 3 or 4;
and M and Hal are each as defined above;
wherein the dye of the general formula (III) when V³⁻¹ to V³⁻¹² independently represent hydrogen or —SO₃M contains at least one structural element of the formula 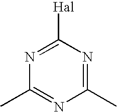
where Hal is as defined above;
or of the general formula (IV) 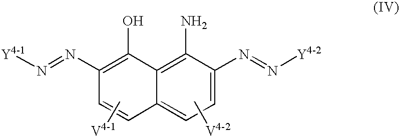
where
Y⁴⁻¹ represents the group of the formula 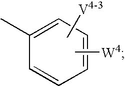
Y⁴⁻² has the same meanings as Y⁴⁻¹ or represents one of the following groups: 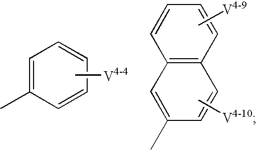
W⁴ represents vinyl sulfone or ethyl sulfone, substituted in the β-position by an alkali-eliminable substituent or —NR⁴⁻¹ D⁴;
D⁴ represents one of the following groups: 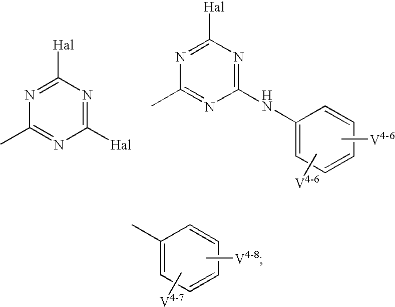
V⁴⁻¹ to V⁴⁻⁴ and V⁴⁻⁹ to V⁴⁻¹⁰ independently represent hydrogen or —SO₃M;
R⁴⁻¹ represents hydrogen, methyl or ethyl;
V⁴⁻⁵ to V⁴⁻⁷ independently represent hydrogen, —SO₃M, vinyl sulfone or ethyl sulfone, substituted in the β-position by an alkali-eliminable substituent; and
V⁴⁻⁸ represents vinyl sulfone or ethyl sulfone, substituted in the β-position by an alkali-eliminable substituent;
and
and M is as defined above.

12. The dye mixture as claimed in claim 11 comprising a dye of the formula (Ia) 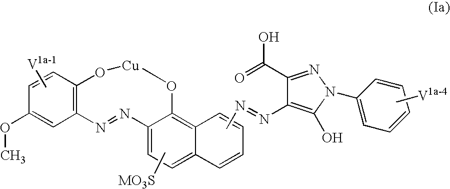
where
V^{1a-1} represents vinyl sulfone, sulfatoethyl sulfone or chloroethyl sulfone;
V^{1a-4} represents hydrogen, —SO₃M, vinyl sulfone, sulfatoethyl sulfone or chloroethyl sulfone; and
M represents hydrogen, sodium or potassium,
and at least one further dye of the formulae (II), (III) or (IV).

13. The dye mixture as claimed in claim 11 comprising at least one dye of the formula (I) and at least one further dye of the formula (IIb) 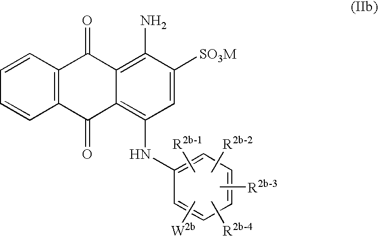
wherein
R^{2b-1} to R^{2b-4} independently represent hydrogen, —SO₃M, methyl or —COOR^{2b-5};
W^{2b} represents NR^{2b-6}D^{2b};
R^{2b-5} and R^{2b-6} independently represent hydrogen, methyl or ethyl;
D^{2b} represents one of the following groups: 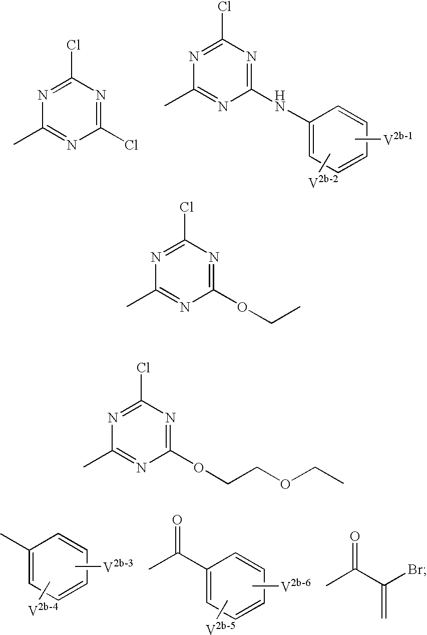
V^{2b-1} and V^{2b-2} independently represent hydrogen, —SO₃M, vinyl sulfone, sulfatoethyl sulfone or chloroethyl sulfone;
V^{2b-3} and V^{2b-5} independently represent vinyl sulfone, sulfatoethyl sulfone or chloroethyl sulfone;
V^{2b-4} and V^{2b-6} independently represent hydrogen or —SO₃M; and
M represents hydrogen, sodium or potassium.

14. The dye mixture as claimed in claim 12 comprising at least one dye of the formula (Ia) and at least one further dye of the formula (IIb) 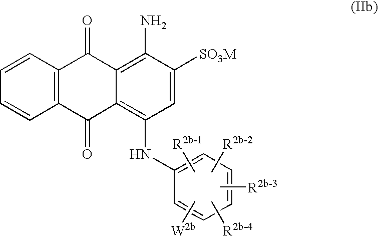
wherein
R^{2b-1} to R^{2b-4} independently represent hydrogen, —SO₃M, methyl or —COOR^{2b-5};
W^{2b} represents NR^{2b-6}D^{2b};
R^{2b-5} and R^{2b-6} independently represent hydrogen, methyl or ethyl;
D^{2b} represents one of the following groups: 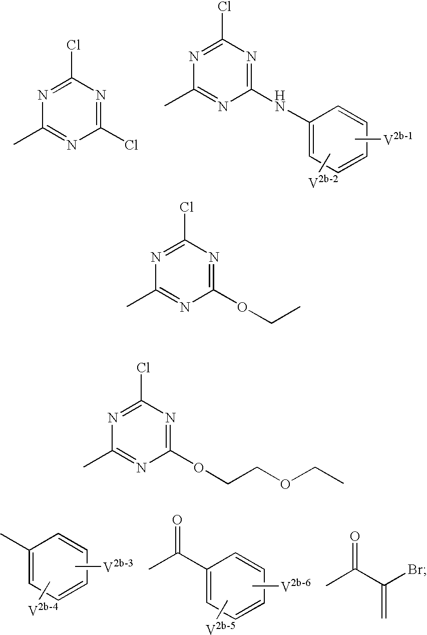
V^{2b-1} and V^{2b-2} independently represent hydrogen, —SO₃M, vinyl sulfone, sulfatoethyl sulfone or chloroethyl sulfone;
V^{2b-3} and V^{2b-5} independently represent vinyl sulfone, sulfatoethyl sulfone or chloroethyl sulfone;
V^{2b-4} and V^{2b-6} independently represent hydrogen or —SO₃M; and
M represents hydrogen, sodium or potassium.

15. The dye mixture as claimed in claim 11 comprising at least one dye of the formula (I) and at least one further dye of the formula (IIIb) 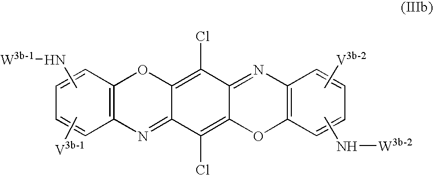
where
W^{3b-1} and W^{3b-2} independently represent hydrogen, (C₁-C₄)-alkyl, (C₁-C₄)-alkyl substituted by —OSO₃M or represent one of the following groups: 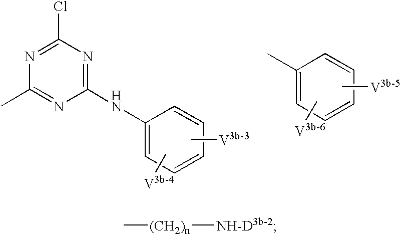
D^{3b-2} independently represents one group of the formulae 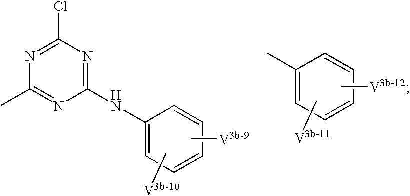
V^{3b-1} to V^{3b-5} and V^{3b-9} to V^{3b-11} independently represent hydrogen, SO₃M, vinyl sulfone, sulfatoethyl sulfone or chloroethyl sulfone;
V^{3b-6} and V^{3b-12} represent vinyl sulfone, sulfatoethyl sulfone or chloroethyl sulfone;
n represents the number 1, 2, 3 or 4; and
M represents hydrogen, sodium or potassium.

16. The dye mixture as claimed in claim 12 comprising at least one dye of the formula (Ia) and at least one further dye of the formula (IIIb) 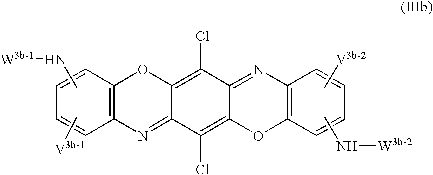
where
W^{3b-1} and W^{3b-2} independently represent hydrogen, (C₁-C₄)-alkyl, (C₁-C₄)-alkyl substituted by —OSO₃M or represent one of the following groups: 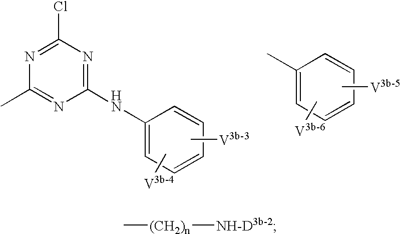
D^{3b-2} independently represents one group of the formulae 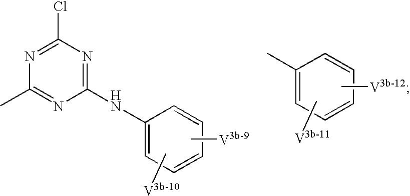
V^{3b-1} to V^{3b-5} and V^{3b-9} to V^{3b-11} independently represent hydrogen, SO₃M, vinyl sulfone, sulfatoethyl sulfone or chloroethyl sulfone;
V^{3b-6} and V^{3b-12} represent vinyl sulfone, sulfatoethyl sulfone or chloroethyl sulfone;
n represents the number 1, 2, 3 or 4; and
M represents hydrogen, sodium or potassium.

17. The dye mixture as claimed in claim 11 comprising at least one dye of the formula (I) and at least one further dye of the formula (IVb) 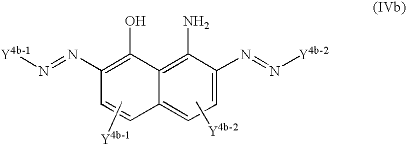
where
Y^{4b-1} represents the group of the formula 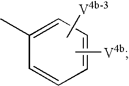
Y^{4b-2} has the same meanings as Y^{4b-1} or represents one of the following groups: 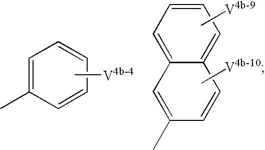
W^{4b} represents vinyl sulfone, sulfatoethyl sulfone, chlorosulfone or NR^{4b-4}D^{4b};
D^{4b} represents a group of the formulae 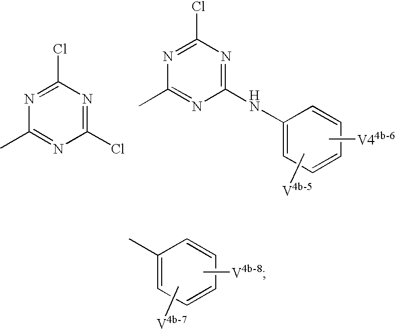
where
V^{4b-1} to V^{4b-3} and V^{4b-9} to V^{4b-10} independently represent hydrogen or SO₃M;
V^{4b-5} to V^{4b-7} independently represent hydrogen, SO₃M, vinyl sulfone, sulfatoethyl sulfone or chloroethyl sulfone;
V^{4b-8} represents vinyl sulfone, sulfatoethyl sulfone or chloroethyl sulfone;
R^{4b-4} represents hydrogen, methyl or ethyl; and
M represents hydrogen, sodium or potassium.

18. The dye mixture as claimed in claim 12 comprising at least one dye of the formula (Ia) and at least one further dye of the formula (IVb) 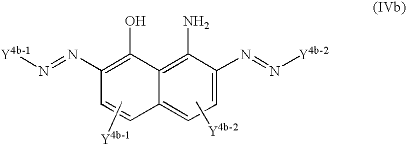
where
Y^{4b-1} represents the group of the formula 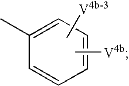
Y^{4b-2} has the same meanings as Y^{4b-1} or represents one of the following groups: 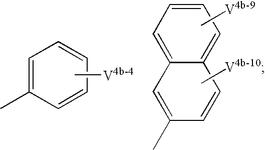
W^{4b} represents vinyl sulfone, sulfatoethyl sulfone, chlorosulfone or NR^{4b-4}D^{4b};
D^{4b} represents a group of the formulae 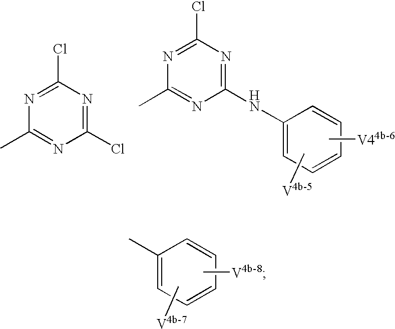
where
V^{4b-1} to V^{4b-3} and V^{4b-9} to V^{4b-10} independently represent hydrogen or SO₃M;
V^{4b-5} to V^{4b-7} independently represent hydrogen, SO₃M, vinyl sulfone, sulfatoethyl sulfone or chloroethyl sulfone;
V^{4b-8} represents vinyl sulfone, sulfatoethyl sulfone or chloroethyl sulfone;
R^{4b-4} represents hydrogen, methyl or ethyl; and
M represents hydrogen, sodium or potassium.

19. The dye mixture as claimed in claim 14 comprising at least one dye of the formula (Ia) and at least one further dye of the formula (IIb).

20. The dye mixture as claimed in claim 16 comprising at least one dye of the formula (Ia) and at least one further dye of the formula (IIIb).

21. The dye mixture as claimed in claim 18 comprising at least one dye of the formula (Ia) and at least one further dye of the formula (IVb).

22. The dye mixture as claimed in claim 11 comprising dyes of the general formula (I) in amounts of 90% to 10% by weight and the dyes of the general formulae (II) or (III) or (IV) in amounts of 10% to 90% by weight.

23. The process for preparing a dye mixture as claimed in claim 11 which comprises mechanically mixing the individual dyes of the general formulae (I) and (II), (III) or (IV) together.

24. A process for dyeing or printing hydroxyl- and/or carboxamido-containing material which comprises contacting the material with the dye mixture as claimed in claim 11.

25. An aqueous ink for digital printing comprising the dye mixture as claimed in claim 11.
